(19) United States
(12) Patent Application Publication
(10) Pub. No.: US 2018/0054106 A1
(43) Pub. Date: Feb. 22, 2018

(54) MAGNETIC PISTON

(71) Applicant: Jerome Walter Michael Loach, Richmond, VA (US)

(72) Inventor: Jerome Walter Michael Loach, Richmond, VA (US)

(21) Appl. No.: 15/239,995

(22) Filed: Aug. 18, 2016

(51) Int. Cl. H02K 7/075

(52) U.S. Cl. CPC H02K 7/075; H02K 53/00; Y10S 74/09

(57) ABSTRACT

A magnetic piston assembly that includes: a piston sleeve; a magnetic head adapted to engage the piston sleeve, where the magnetic head includes a first polarity; a mechanism to apply a second polarity to the magnetic head, where said mechanism to apply causes movement of the piston sleeve and magnetic head within a chamber; and an opening at the bottom of the piston sleeve, where said opening is adapted to engage a connecting rod.

### BACKGROUND OF THE INVENTION

### Field of Invention

The present invention relates to a magnetic piston that serves as a replacement for the traditional internal combustion engine.

### Description of Related Art

Internal combustion engines are used in many vehicles as the primary power source to turn a crankshaft that in turn powers the movement of the vehicle. It is well known most internal combustion engines operate through the use of a fossil fuel such as gasoline. However, there are certain side effects related to the use of fossil fuels that affect the environment. The burning of fossil fuels emits carbons into the air and thus is a major source of pollution and greenhouse gases. Further the extraction of fossil fuels can be hazardous to the environment due to possible oil spills or otherwise. As such the fossil fuel consumption has a wide ranging effect on the environment.

Alternatives for fossil fuels have been explored in the form of electric and hybrid vehicles. However electrically powered vehicles are limited in range and speed. Further electric cars need constant charging such vehicles which could be inconvenient for the drivers and not as effective as a traditional gasoline engine. As a result, further development of alternative energy sources for transportation are needed.

### SUMMARY OF THE INVENTION

The present invention relates to a magnetic piston assembly that includes: a piston sleeve; a magnetic head adapted to engage the piston sleeve, where the magnetic head includes a first polarity; a mechanism to apply a second polarity to the magnetic head, where said mechanism to apply causes movement of the piston sleeve and magnetic head within a chamber; and an opening at the bottom of the piston sleeve, where said opening is adapted to engage a connecting rod.

### BRIEF DESCRIPTION OF DRAWINGS

FIG. 1 depicts a magnetic piston in accordance with the present invention.

### DETAILED DESCRIPTION

The present invention relates to a magnetic piston as developed to replace the traditional piston of an internal combustion engine. The magnetic piston according to present invention provides an alternative piston that uses magnetism at the primary power source. The magnetic piston according to present invention includes a magnetic head attached to a piston sleeve. Other components of the engine are non-magnetic, where repulsion is used to propel the piston within the combustion chamber. This magnetic repulsion moves the piston in a vertical manner similar to a gasoline powered internal combustion engine where the piston is attached to a connecting rod that turns a crankshaft. The use of this magnetic repulsion eliminates the need for the consumption of fossil fuels.

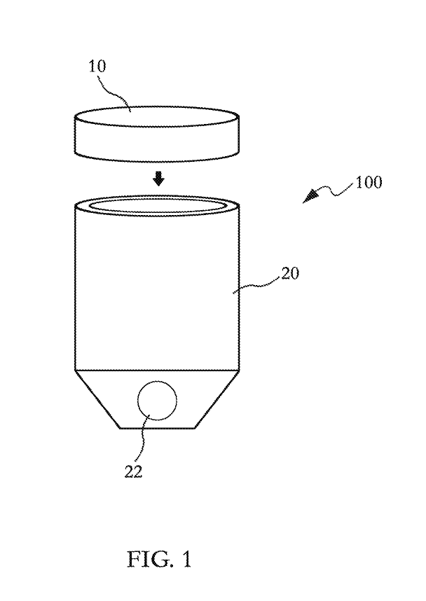

In reference to FIG. 1, a schematic design of a magnetic piston 100 of the current invention is depicted. The magnetic piston 100 is shown with a magnetic head 10 that is attached to a piston sleeve 20. Once attached to the piston sleeve 20 the piston assembly is inserted into combustion chamber that operates with the magnetic forces that repulse the magnetism of the magnetic head 10 causing the piston to move within a combustion chamber. The piston sleeve includes an opening 22 shown at the lower end of the piston sleeve 20. This opening 22 attaches to a connecting rod similar to a traditional piston. The connecting rod (not shown) is attached to a crankshaft therefore driving the crankshaft of a vehicle. Magnetic force is applied within the combustion chamber to therefore execute the movement of the piston within the chamber. The instant invention has been shown and described in what it considers to be the most practical and preferred embodiments. It is recognized, however, that departures may be made there from within the scope of the invention and that obvious modifications will occur to a person skilled in the art.

What is claimed is:

1. A magnetic piston assembly comprising:
a. a piston sleeve;
b. a magnetic head adapted to engage the piston sleeve, where the magnetic head includes a first polarity;
c. a means to apply a second polarity to the magnetic head, where said means to apply causes movement of the piston sleeve and magnetic head within a chamber; and
d. an opening at the bottom of the piston sleeve, where said opening is adapted to engage a connecting rod.

2. A system for implementing magnetic repulsion into a combustion chamber comprising:
a. a piston assembly, where said piston assembly replaces an internal combustion piston, wherein the piston assembly includes a piston sleeve and a magnetic head adapted to engage the piston sleeve, where the magnetic head includes a first polarity; and
b. a means to apply a second polarity to the magnetic head, where said means to apply causes movement of the piston sleeve and magnetic head within a chamber.
